(19) United States
(12) Patent Application Publication
(10) Pub. No.: US 2012/0011076 A1
(43) Pub. Date: Jan. 12, 2012

(54) SMARTPHONE-IMPLEMENTED METHOD OF OBTAINING A FISHING OR HUNTING LICENSE

(76) Inventor: Jonathan A. Crissy, Davie, FL (US)

(21) Appl. No.: 12/844,349

(22) Filed: Jul. 27, 2010

Related U.S. Application Data
(60) Provisional application No. 61/322,367, filed on Apr. 9, 2010.

(51) Int. Cl. G06Q 30/00; H04W 4/00; G06F 17/30

(52) U.S. Cl. 705/311; 707/706; 455/414.1; 707/E17.014; 707/E17.107

(57) ABSTRACT

The present invention is related to a smartphone-implemented method of obtaining fishing or hunting license, comprising the steps of:
a) Establishing online communication between a smartphone and a fishing and hunting license server;
b) downloading a fishing and hunting license application to the smartphone;
c) selecting the state and county in which the fishing or hunting activity will be performed;
d) selecting the animal right the fisherman or hunter is planning to catch or hunt;
e) reading and accepting the animal information, including slot, bag and harvest season limits and regulations;
f) selecting the type of license needed for performing the fishing or hunting activity;
g) inserting the fisherman's or hunter's personal information;
h) paying the license fees;
i) validating the user data and the payment information data;
j) issuing and sending the license certificate from the fishing and hunting license server;
k) storing the license certificate in the smartphone memory.

By using the above mentioned online application, the user is able to obtain a fishing or hunting license without the need of going to a specialized store.

### CROSS REFERENCE TO RELATED APPLICATION

This application claims the benefit of co-pending U.S. Provisional Patent Application Ser. No. 61/322,367, filed on Apr. 9, 2010, which is incorporated herein within its entirety.

### BACKGROUND OF THE INVENTION

1. Field of the Invention

The present invention relates generally to hunting and/or fishing licenses. The invention is, however, more particularly directed to a hunting and fishing license system that allows the users to purchase and store fishing and hunting licenses on their smartphones.

2. Description of the Prior Art

Fishing is the sport of catching fish, freshwater or saltwater, typically with rod, line, and hook. Like hunting, fishing originated as a means of providing food for survival, and is an ancient practice that dates back to the beginning of the human history.

Fishing as a sport is also of considerable antiquity. An Egyptian angling scene dating from about 2000 BC shows figures fishing with rod and line and with nets. A Chinese account from about the 4th century BC refers to fish with a silk line, a hook made from a needle, and a bamboo rod, with cooked rice as bait. References to fishing are also found in ancient Greek, Assyrian, Roman, and Jewish writings.

Today, fishing, often called sport fishing to distinguish it from commercial fishing, is one of man's principal relaxations and is, in many countries, the most popular participant sport.

Recreational and sport fishing describes fishing for pleasure or competition. Recreational fishing has conventions, rules, licensing restrictions and laws that limit the way in which fish may be caught; typically, these prohibit the use of nets and the catching of fish with hooks not in the mouth. The most common form of recreational fishing is done with a rod, reel, line, hooks and any one of a wide range of baits or artificial lures such as spinners, or ‘dry flies’. The practice of catching or attempting to catch fish with a hook is generally known as angling. In angling, it is sometimes expected or required that fish be returned to the water (catch and release). Recreational or sport fishermen may log their catches or participate in fishing competitions.

During the last decades, the federal and state level authorities have understood the importance of controlling the type, frequency and volume of fishing and hunting activities, in order to protect this wonderful natural resource. With this type of restrictive measures authorities tend to avoid the “Overfishing”. Overfishing occurs when fishing activities reduce fish stocks below an acceptable level. This can occur in any body of water from a pond to the oceans. Ultimately overfishing may lead to resource depletion in cases of subsidized fishing, low biological growth rates and critical low biomass levels.

Every state has their own enforcement authority to control hunting and fishing activities. Nowadays, there are regulations in every state to control when, where and how people fish and hunt. One of the mandatory requisites before starting this activity is to obtain a license. A license allows the fisherman to catch fish only in specific zones during specific times of the year. Disobeying these regulations has, in many states, very serious consequences.

Hunting licenses are also issued by governmental authorities for protecting and controlling the game animal population, as a source of revenue, and ensure that hunters are qualified to use weapons in a safe manner. Such hunting licenses are printed on forms, which provide at least a license document which the hunter or fisherman carries as evidence that he/she is authorized to be hunting or fishing, and, which is fixed to an animal carcass as evidence that the animal was killed by a licensed person. Also, the form from which the license document is produced also includes a record portion to be retained by the agent who issued the license.

The way fishermen and hunters obtain a license has been changing during the last two decades. First, the user must go to a specialized fishing or hunting store to buy a license. There are usually hundred of stores around every state in which fishing or hunting license can be obtained.

However, the recent explosive growth of electronic commerce has led to a proliferation of websites on the Internet selling products as diverse as toys, books and automobiles, and providing services, such as insurance and stock trading. Millions of consumers are presently surfing through web sites in order to gather information, to make purchases, or to use purely for entertainment.

Providing a service to the web can offer tremendous advantages because the process instantly becomes accessible to web browsers on millions of personal computers worldwide. Furthermore, by making the process available on a website, users can interact with the process in an automated manner, without requiring assistance from a customer service representative. This automation can dramatically reduce the cost of providing the process.

One process that is being adapted to the web is the issuance of licenses, such as fishing and hunting licenses. Almost every state has an online system for purchasing a fishing license. Just as an example, in the state of Florida, the Florida Fish and Wildlife Conservation Commission offers an online system called “Total Licensing System” that provides a secure, easy and convenient method for purchasing a Florida license. The system works as follows: the user is asked to indicate whether or not he/she is a Florida resident and personal identification is required. This will let the authorities know which Florida licenses are available for the user to purchase. The following personal information must be provided: name, address, birth date, Florida Driver's License or Customer ID Number. Then, the license(s) or permits) the user wants to buy must be selected and added to the shopping cart. By using a valid credit card, the license fees must be paid. A receipt and a Temporary Authorization Number (TAN) are obtained online to print or record. The TAN will allow the user to hunt or fish immediately. This license system requires the user to print the record and keep it until the official license in the mail is received. Licenses are usually mailed within 48 hours of the online purchase; normal delivery time is 5-7 business days. You may request FedEx overnight shipping for an additional fee.

From the above, it is obvious that the license should be purchased in advance, and many days usually pass before the original paper-based license is received. In other states, the user can print the certificate, but the paper evidence is always required.

One of the main drawbacks of this system is the fact that the paper license is not replaceable. The main concern about allowing the user to print the certificate is concerned with the authenticity of these documents. In fact, there are several methods for encoding license parameters within a license number for authentication purposes. For example, a method is known for generating a license number based upon license parameters so that the license number can be authenticated by establishing that the license number was generated using the license parameters. The method comprises: receiving license parameters from a person requesting a license; encoding the license parameters into a license number so that the license parameters can be restored by decoding the license number; wherein the license parameters cannot be determined from the license number without decoding the license number and wherein encoding the license parameters includes using a pre-computed random permutation to perform the encoding; rotating a result of the pre-computed random permutation by a first random rotation distance; incorporating a first rotation index specifying the first random rotation distance into the license number; and facilitating printing of the license for the person requesting the license; wherein the license includes the license number.

Bringing the paper license to the fishing place also involves other inconveniences. For example, the possibility of ruining the paper during the fishing or hunting activities. As the license may be requested by the authorities at any moment, the fisherman or hunter must carry it all the time in one of his/her pockets.

Conventional paper hunting and fishing licenses are often not protected from moisture, chemicals or wear. If they are protected, such as by a plastic coating, then it is impossible to permanently enter catch or bag data on them. Therefore, this information must be entered on separate documents. Furthermore, conventional fishing and hunting licenses are relatively easy to reproduce on photocopiers, and can fade if exposed to sunlight. In general, it is difficult for conventional licenses to provide readily readable catch or bag record information for extended periods of time (typically a year for most licenses).

There are several inventions in the prior art for protecting the paper fishing licenses. For example, a business form is provided, which is ideally suited for licenses, particularly fishing and hunting licenses, and, which overcomes the problems with conventional licenses. The business form protects the license permanently from moisture, chemicals and wear.

Another online hunting or fishing license system solution comprises forms suitable for issuance at a computerized point of sale terminal and printer. The hunting license forms are provided in a continuous web of forms with pin feed tractor holes, each form having a license tag portion and a record portion. The marginal edge of the license tag portion has a reinforcing strip overlyingly adhered thereto such that the pin feed holes may also be used for the passage of a cord for attaching the tag to an animal carcass. The forms are marked with a design and have regions of contrasting color, which make the forms difficult to counterfeit. The forms are preprinted basic, non-variable information such that one form may be used to provide several types of licenses.

However, none of these solutions solve the problem posed by a fisherman or hunter who wants to purchase a fishing or hunting license and he/she is far away from any known bait shop or store where usually a fishing or hunting license may be purchased. Alternatively, a fisherman or hunter who is fishing or hunting with friends but only one license was purchased, and one of the friends wants to fish or hunt and no license can be purchased. The aim of the present invention is to offer the user the possibility of obtaining fishing or hunting licenses if he/she may be far away from any authorized store, by using a smartphone.

Even though the above cited fishing and hunting license systems address some of the needs of the market, a new improved online fishing and hunting license system and a method of use with a smartphone is still desired.

### SUMMARY OF THE INVENTION

This invention is directed to a hunting and fishing license system and method for use with a smartphone which allows the user to purchase and store electronic fishing and hunting licenses on their smartphones.

In one general aspect of the present invention, the hunting and fishing license system and method for use with a smartphone is disclosed, with which the paper-based old form of fishing and hunting licenses is replaced by a modern, online electronic solution that will not only provide a convenient service to fishermen and hunters but will also increase the revenues of the respective states in which the system is applied.

Accordingly, it is a primary object of the present invention to provide a fishing and hunting license system with which it is no longer necessary to carry around another extra piece of paper in the pocket.

Another aspect of the present invention provides fishing and hunting license system that avoids the inconveniences of having to drive to a location to purchase a license.

In summary, the present invention is related to a smartphone-implemented method of obtaining a fishing or hunting license, comprising the steps of:
a) Establishing online communication between a smartphone and a fishing and hunting license server;
b) downloading a fishing and hunting license application to the smartphone;
c) selecting the state and county in which the fishing or hunting activity will be performed,
d) selecting the animal right the fisherman or hunter is planning to catch or hunt;
e) reading and accepting the animal information, including slot, bag and harvest season limits and regulations;
f) selecting the type of license needed for performing the fishing or hunting activity;
g) inserting the fisherman's or hunter's personal information;
h) paying the license fees;
i) validating the user data and the payment information data;
j) issuing and sending the license certificate from the fishing and hunting license server;
k) storing the license certificate in the smartphone memory.

These and other aspects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 is a front view of the screen of a smartphone in which the application has been downloaded in accordance with the present invention. The image shows an example of the icon that may be used in the smartphone home page that identifies the fishing and hunting license authorities, in this particular case of the state of Florida.

FIG. 2 shows the home page after the user clicks on the icon shown in FIG. 1.

FIG. 3 shows the screen on which the user must choose the state in which the recreational fishing or hunting activity will be performed.

FIG. 4 shows the screen on which the user must select the county (of the state selected in FIG. 2) in which the recreational fishing or hunting activity will be performed.

FIG. 5 shows the different fish rights from which the user must select. This screen includes a search field to speed up the selection process.

FIG. 6 shows the Fish Right chosen, including, for example, the Slot Limit, the Bag Limit and the Harvest Season.

FIG. 7 shows a screen similar to the screen of FIG. 5 but this time the user must select the Wildlife Rights for a hunting activity.

FIG. 8 shows a screen similar to FIG. 6 but for the specific hunting activity selected in FIG. 7. As in the previous case, the Bag Limit and the Harvest Season may be part of the information shown.

FIG. 9 shows the License/Permit's screen on which the user may retrieve a license already purchased or purchase a new one.

FIG. 10 shows the different types of fishing licenses and permits the user can obtain online.

FIG. 11 shows a screen similar to FIG. 9 including the possibility of obtaining hunting licenses and permits.

FIG. 12 shows an example of different types of fishing permits for Saltwater the user can obtain online.

FIG. 13 shows the payment process screen, in which the user must provide personal and payment information.

FIG. 14 shows an example of a fishing or hunting license certificate that the user receives once the whole purchase process is completed successfully; and finally:

FIG. 15 shows an example of a ‘News’ screen in which the user may learn about the latest changes in the rules and regulations and/or any useful information the authorities may publish in their website.

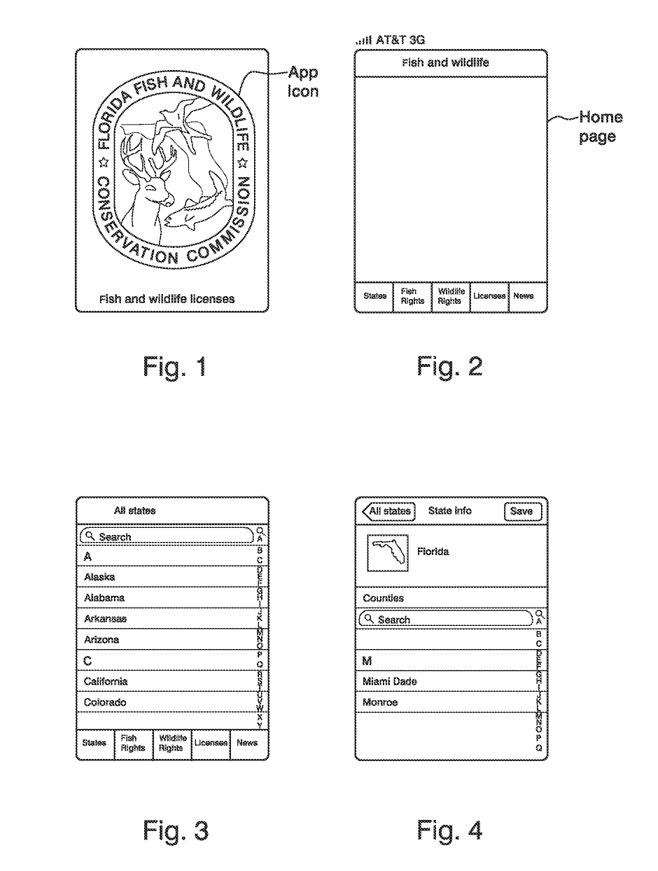

### DETAILED DESCRIPTION OF REPRESENTATIVE EMBODIMENTS

A smartphone is a mobile phone offering advanced capabilities, often with PC-like functionality (PC-mobile handset convergence). It is a phone that runs complete operating system software providing a standardized interface and platform for application developers.

For the first time ever, smartphones with touch screens accounted for more than half of all smartphone shipments globally in Q4 2009, taking 55% of the market, according to the latest estimates. Touch screen smartphone shipments were up to 138% year on year in Q4, reaching almost 30 million units, in a quarter where overall smartphone market growth stood at 41%. Total touch-screen smartphone shipments for the year were over 75 million, more than double the 2008 figure. Total smartphone shipments in 2009 hit a new peak of 166 million units.

The above cited numbers show clear trends about the type of phone users are choosing. Applications developed for smartphones like iPhone® or Blackberry® are very popular and a regular smartphone customer is completely familiar with online applications downloaded in their smartphones.

The aim of the present invention is an online downloadable application for smartphones with which the users may purchase and store fishing and hunting license avoiding the inconveniences of going to bait stores to obtain this license.

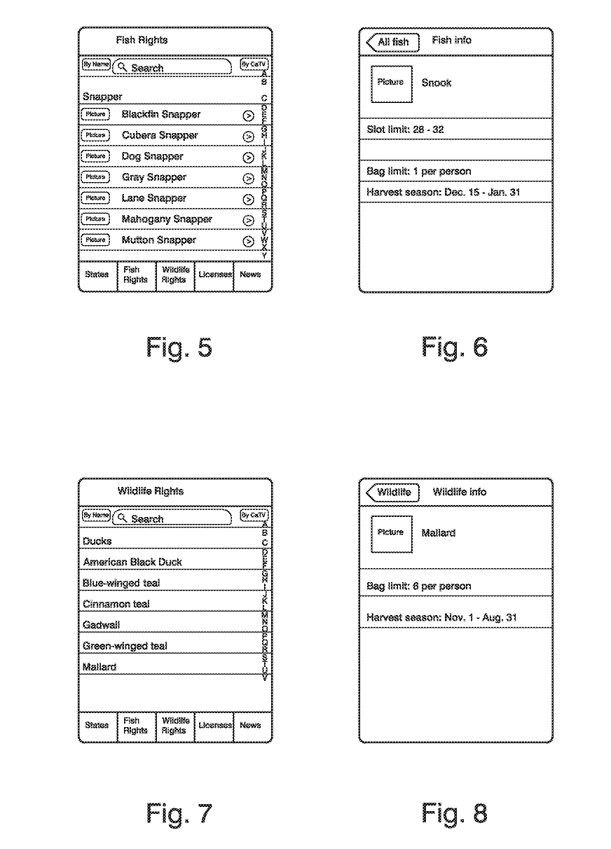

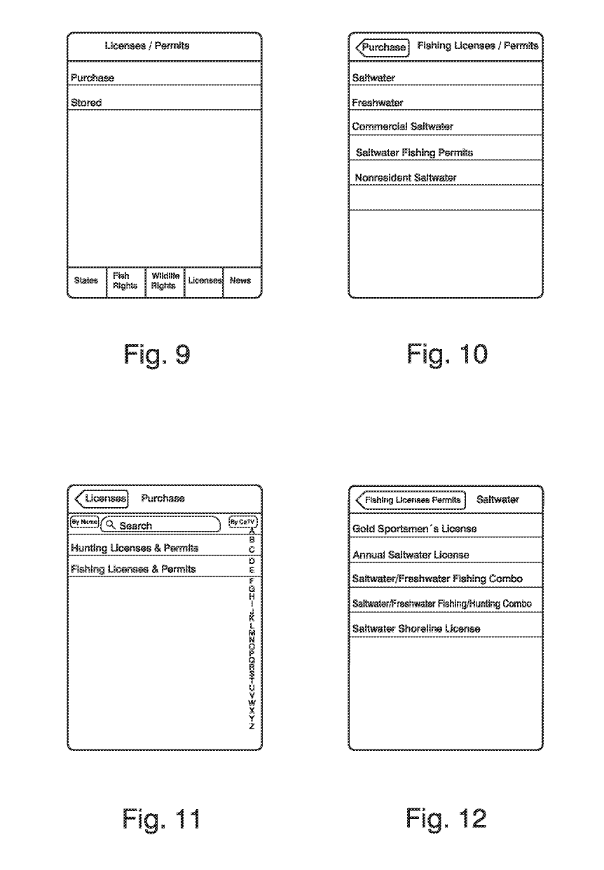

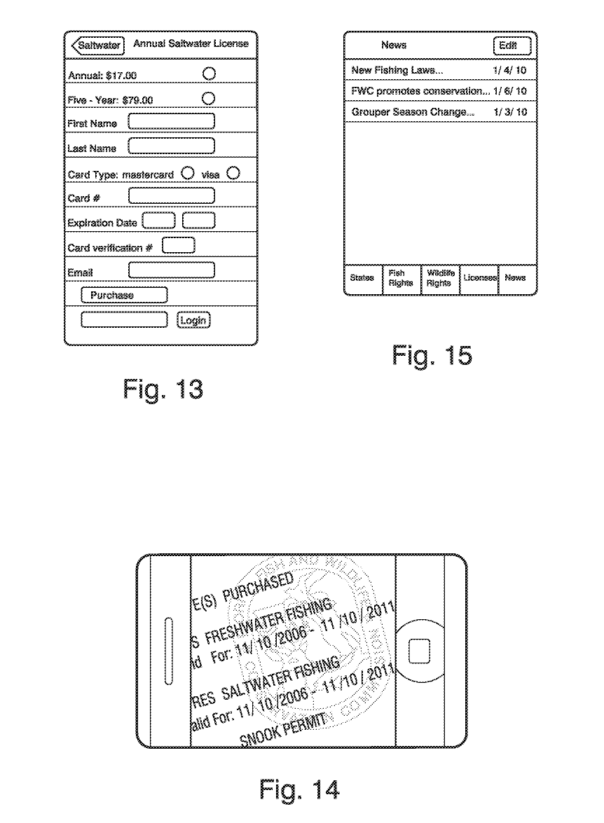

The present invention basically comprises the following steps:
a) Establishing online communication between a smartphone and the fishing and hunting license server. In order to avoid authenticity problems, the application can only be downloaded from the authority's website. By doing this, the authority avoids fraud and the user may rely on an official website, basically considering that sensitive information is provided during the license purchasing process. To start the download process, the user must establish an online connection between his smartphone and the authority's website.
b) Downloading the fishing and hunting license application to the smartphone. The download process is identical to the downloading process users usually perform for obtaining a regular application for the smartphone, like Global Positioning System (GPS) applications, game applications, etc. The typical steps involved in this downloading process may include the steps of: a) opening an internet browser in the smartphone; b) accessing to a wireless internet connection; c) accessing to the fishing and hunting authorities' website; d) clicking on the “download application” icon on the website; and e) storing the application in the smartphone memory device.
c) Selecting the state and county in which the fishing or hunting activity will be performed (see FIGS. 3 and 4). The first step is to provide the authorities with the information about where the fishing or hunting activity will be performed. In almost every state there are hundreds of different places and each place has its own particularities, seasons, etc. Therefore, selecting the place will allow the application to provide the information about the rules and regulations, type of licenses and permits available, etc.
d) Selecting the animal rights the fisherman or hunter is planning to catch or hunt. In the illustrated embodiment, FIG. 5 shows different Fish Rights. A list of fish available in the region chosen is listed. For example, Black-fin Snapper, Cubera Snapper, Dog Snapper, Gray Snapper, lane Snapper, Mahogany Snapper, Mutton Snapper, etc. During this step, and in order to speed up the selection process, the interface also provides a search engine field with which the user may insert the name of the fish he/she is interested in and the system will immediately retrieve the information for this particular fish.
e) Reading and accepting the animal information, including slot, bag and harvest season limits and regulations. As illustrated in FIG. 6, once the fish is selected, the Fish Info is shown. In this particular embodiment, the Slot Limit, Bag Limit and Harvest season are shown. A small picture of the fish is also included, to help the user check if the fish selected during the previous step is the fish he is interested in. FIGS. 7 and 8 illustrate an example of the animal rights selection for hunting activities. For example, in FIG. 7 the user must select between the different names of Wildlife Rights, including American Black Duck, Blue winged Teal, Cinnamon Teal, Gadwall, Green-winged Teal, Mallard, etc. If the user chooses, for example, Mallard, then FIG. 8 shows the next screen in which a small picture of a Mallard and the Bag limit and harvest season may be shown.
f) Selecting the type of license needed for performing the fishing or hunting activity. Depending on the recreational activity, there are different types of licenses and permits. For example, on the screen illustrated in FIGS. 9 and 10, the user must select between the different fishing licenses, namely: Saltwater, Freshwater, Commercial Saltwater, Saltwater Fishing Permits, and Non-resident Saltwater. FIGS. 11 and 12 show an example of the screens shown once the user selects Saltwater fishing activities, namely: Gold Sportsman's License, Annual Saltwater License, Saltwater/Freshwater Fishing Combo, Saltwater/Freshwater Fishing/Hunting Combo, or Saltwater Shore Line License.
g) Inserting the fisherman or hunter personal information. In order to allow the authorities to identify the user, personal identification information must be inserted, including the name, address, email, driver's license number, etc.
h) Paying the license fees. Credit Card information must be inserted during this step, for paying the official license fees.
i) Validating the user data and the payment information data. Once the information is inserted, the license server validates these data and approves the request. The payment is processed using regular POS software applications.
j) Issuing and sending the license certificate from the fishing and hunting license server. Once the process is completed successfully, the user receives an attachment including an image of the licenses' certificate requested. This image may include security features, for avoiding fraud. See FIG. 18.
k) Storing the license certificate in the smartphone memory. The certificate may be stored in the memory of the user's smartphone. If the authority requires checking the permit, then the user may show the image in the smartphone including the security features, and no paper-based license will then be required.

Even though in the present description the method is focused on obtaining hunting and fishing licenses, this should not be interpreted as a limitation of the present invention. Other types of licenses may also be implemented, including safety licenses, boating licenses, etc.

While the preferred embodiments of the invention have been described above, it will be recognized and understood that various modifications can be made in the invention and the appended claims are intended to cover all such modifications which may fall within the spirit and scope of the invention.

I claim:

1. A smartphone-implemented method of obtaining a fishing or hunting license, comprises the steps of:
a) Establishing online communication between a smartphone and a fishing and hunting license authorities' server;
b) downloading a fishing and hunting license application to the smartphone;
c) selecting the state and county in which the fishing or hunting activity will be performed;
d) selecting the animal right the fisherman/hunter is planning to catch/hunt;
e) reading and accepting the animal information, including slot, bag and harvest season limits and regulations;
f) selecting the type of license needed for performing the fishing/hunting activity;
g) inserting the fisherman's/hunter's personal information;
h) paying the license fees;
i) validating the user data and the payment information data;
j) issuing and sending the license certificate from the fishing and hunting license server;
k) storing the license certificate in the smartphone memory.

2. The smartphone-implemented method of obtaining a fishing or hunting license of claim 1, wherein the fishing and hunting license server is the server of the official state level authorities in charge of issuing hunting/fishing licenses.

3. The smartphone-implemented method of obtaining a fishing or hunting license of claim 1, wherein the communication between the smartphone and the fishing and hunting license server is performed through a wireless cellular network.

4. The smartphone-implemented method of obtaining a fishing or hunting license of claim 1, wherein the steps of downloading a fishing and hunting license application to the smartphone comprises the steps of:
a) opening an internet browser in the smartphone;
b) accessing to a wireless internet connection;
c) accessing to the fishing and hunting authorities' website;
d) clicking on the “download application” icon on the website;
e) storing the application in the smartphone memory device.

5. The smartphone-implemented method of obtaining a fishing or hunting license of claim 1, wherein the fishing and hunting license authorities are the Florida Fish and Wildlife Conservation Commission.

6. The smartphone-implemented method of obtaining a fishing or hunting license of claim 1, wherein the smartphone is an iPhone®.

7. The smartphone-implemented method of obtaining a fishing or hunting license of claim 1, wherein the smartphone is a BlackBerry®.

8. The smartphone-implemented method of obtaining a fishing or hunting license of claim 5, wherein during the selection process of the state and county in which the fishing or hunting activity will be performed, FLORIDA-MIAMI DADE is chosen.

9. The smartphone-implemented method of obtaining a fishing or hunting license of claim 1, wherein during the selection process of the animal right the fisherman is planning to catch, the user may select between: Black-fin Snapper, Cubera Snapper, Dog Snapper, Gray Snapper, lane Snapper, Mahogany Snapper, Mutton Snapper.

10. The smartphone-implemented method of obtaining a fishing or hunting license of claim 9, wherein during this step, the interface provides a search engine field in which the name of the fish may be inserted and the information for this particular fish is retrieved.

11. The smartphone-implemented method of obtaining a fishing or hunting license of claim 10, wherein as part of the information provided by the system, the following information is included: slot, bag and harvest season limits and regulations.

12. The smartphone-implemented method of obtaining a fishing or hunting license of claim 1, wherein during the selection process of the animal right the hunter is planning to hunt, the user may select between: American Black Duck, Blue winged Teal, Cinnamon Teal, Gadwall, Green-winged Teal, Mallard.

13. The smartphone-implemented method of obtaining a fishing or hunting license of claim 12, wherein during this step, the interface provides a search engine field in which the name of the animal may be inserted and the information for this particular animal is retrieved.

14. The smartphone-implemented method of obtaining a fishing or hunting license of claim 13, wherein as part of the information provided by the system, the following information is included: slot, bag and harvest season limits and regulations.

15. The smartphone-implemented method of obtaining a fishing or hunting license of claim 1, wherein in step f) the user must select between the different fishing licenses: Saltwater, Freshwater, Commercial Saltwater, Saltwater Fishing Permits, and Non-resident Saltwater.

16. The smartphone-implemented method of obtaining a fishing or hunting license of claim 1, wherein in step g) the following user's information must be inserted: name, address, email, driver's license number.

17. The smartphone-implemented method of obtaining a fishing or hunting license of claim 1, wherein step i) is processed using a regular POS software application.

18. The smartphone-implemented method of obtaining a fishing or hunting license of claim 1, wherein in step j) an attachment including an image of the license certificate requested is received.

19. The smartphone-implemented method of obtaining a fishing or hunting license of claim 18, wherein the image includes anti-fraud security features.

20. The smartphone-implemented method of obtaining a fishing or hunting license of claim 18, wherein the image includes the details of the type of permit, the name of the fisherman/hunter and the amount paid.
